(19) United States
(12) Patent Application Publication
(10) Pub. No.: US 2026/0042062 A1
(43) Pub. Date: Feb. 12, 2026

(54) PLANT AND METHOD FOR THE PURIFICATION OF FUMES AND RECOVERY OF SECONDARY RAW MATERIAL

(71) Applicant: ITALCER S.P.A. SOCIETÀ BENEFIT, Rubiera (IT)

(72) Inventor: Isidoro Giorgio LESCI, Castel Bolognese (IT)

(21) Appl. No.: 19/101,991

(22) PCT Filed: Aug. 4, 2023
(86) PCT No.: PCT/IB2023/057899

§ 371 Date: Feb. 7, 2025

(30) Foreign Application Priority Data
Aug. 9, 2022 (IT) 102022000017034

(51) Int. Cl. B01D 53/96; B01D 53/60; B01D 53/62; B01D 53/78; B01J 10/00; B01J 19/08; B01J 19/24; C01D 5/14; C01D 7/16; C01F 11/18; C01F 11/38; C01F 11/46

(52) U.S. Cl. CPC B01D 53/965; B01D 53/60; B01D 53/62; B01D 53/78; B01J 10/00; B01J 19/087; B01J 19/245; C01D 5/14; C01D 7/16; C01F 11/181; C01F 11/38; C01F 11/464; B01D 2251/404; B01D 2251/604; B01D 2251/80; B01D 2257/302; B01D 2257/404; B01D 2257/504; B01D 2258/0283; B01J 2219/0877

(57) ABSTRACT

The present invention relates to a plant and method for the purification of fumes from industrial discharges and/or for the recovery and reconversion of sulfur oxides and/or nitrogen oxides and/or carbon dioxide contained in said fumes. Said method comprises the passage into one or more aqueous solutions, where said aqueous solutions are selected from the group comprising: —solution with an acid pH, between 0.5-1; —solution at a pH between 3 and 5, at about pH 4; —Ca(OH)₂ or CaCl₂ or calcium acetate solution; —solution at a pH between 8 and 9.

### BACKGROUND ART

The concentration of greenhouse gases in the atmosphere has progressively increased in recent decades, with consequences already observable today at the climatic level.

The 2015 Paris Climate Conference suggested an agreement to keep the average global temperature increase below 2° C. above pre-industrial levels as a long-term goal.

The industry and energy fields covered by the EU carbon market (ETS) must increase the effort to reduce CO₂ emissions by 2030, a gas with a strong environmental impact, from 43 to 61% compared to 2005.

The physical and chemical features of the atmosphere and geosphere determine the climatic conditions of the planet and affect the life of living beings. An air pollutant can be defined as any material which, when introduced into the atmosphere, alters and damages the natural balance thereof, directly or indirectly (Bond R., Straub, C, Prober R.: “CRC Handbook of Environmental Control”, vol. I: Air Pollution, CRC Press Inc., Boca Raton Florida, 4th print, 1980).

Two main groups of pollutants can be identified based on the origin thereof: anthropogenic, i.e., man-made, and natural.

They can also be classified as primary, i.e., released into the environment as such and as a consequence of a process (e.g. CO, CO₂, NOx, SOx), and secondary, which are then formed in the atmosphere through chemical-physical reactions (e.g., photochemical smog) (Lund, R.: “Industrial Pollution Control Handbook”, chapter 9—“Research programs for air and water pollution control”, Mc Graw-Hill, 1971).

With reference to the state of the material, air pollutants are classified as gaseous or particulate. Examples of gaseous pollutants are nitrogen oxides (NO, NO₂), sulfur oxides (SO₂, SO₃), carbon monoxide (CO), carbon dioxide (CO₂), hydrogen sulfide (H₂S), hydrogen fluoride (HF), hydrogen chloride (HCl), ammonium compounds (NH₄), hydrocarbons. Particulate pollutants include powders of all kinds, fumes, mists.

Combustion is the exothermic oxidation of reducing substances by oxygen, commonly that contained in the air. The oxidizable chemical species of fuels are carbon, hydrogen, sulfur, small amounts of nitrogen, and the compounds containing them. For complete combustion, they are transformed into CO₂, H₂O, SOx (SO₂+SO₃) and partially into NOx (NO+NO₂).

With particular reference to the ceramic industry, emissions from firing ovens are the most relevant and complex to manage, where these hot emissions essentially comprise:
Powders of mixtures and, in the case of firing enameled products, enamel, dragged by the gaseous current circulating inside the oven;
Gaseous or particulate products from the reactions or transformations (degradation, collapse for example of clay materials, evaporation and distillation, sublimation) which occur in or between some of the constituents of the support or enamel. Such pollutants include fluorine, chlorine, ammonium, boron, sulfur, lead and other metals, organic substances, etc.;
Combustion products: in particular, in the hypothesis that the fuel used is natural gas, carbon dioxide and nitrogen oxides (as well as of course water vapor).

In the prior art, said fumes are treated with powdered lime. However, said treatment does not allow the retention of sulfur and nitrogen oxides, except in a residual amount.

Therefore, the need is strongly felt to have an economically sustainable and efficient method for the purification of industrial fumes and for the recovery and reconversion of components thereof.

### DESCRIPTION

It is the object of the present invention to provide a plant and method for the purification of industrial exhaust fumes and/or the recovery and reconversion of sulfur oxides and/or nitrogen oxides, and/or carbon dioxide contained therein.

Said fumes are for example fumes produced in combustion, gasification, or chemical processes. In an embodiment, they are fumes produced by blast furnaces, for example blast furnaces for processing ceramics.

Using mild conditions and with low energy demand, operating in aqueous solutions, the method according to the present invention surprisingly leads to high-purity precipitated calcium carbonate (PCC) and/or high-purity sodium bicarbonate and/or calcium sulfate and/or calcium bisulfite and/or calcium nitrate.

Moreover, the method according to the present invention reduces bad odors, volatile organic compounds (VOCs) and heavy metals in the absence of an afterburner.

The method according to the present invention operates not only without CO₂ emissions but consuming the CO₂ contained in the fumes.

These and other objects are achieved by the present invention, as described and claimed below.

### DESCRIPTION OF THE DRAWINGS

FIG. 1: diagram of embodiments of the method according to the present invention. (A) purification of the fumes; (B, C) reconversion of sulfur oxides and/or nitrogen oxides, and/or carbon dioxide.

FIG. 2: diagram of an embodiment of the purification apparatus.

FIG. 3: diagram of an embodiment of a trap reactor.

FIG. 4: analysis of calcium carbonate and calcium sulfate obtained with the method according to the present invention. Calcium sulfate: (A) microcrystals, scanning electron microscope (SEM) photography; (B) EDS microanalysis spectrum. Calcium carbonate precipitated after a passage into trap 3: (C) microcrystals, SEM photography; (D) EDS microanalysis spectrum. Calcium carbonate precipitated from CaCl₂: (E) microcrystals, SEM photography; (F) EDS microanalysis spectrum.

FIG. 5: X-ray analysis spectrum of (A) calcium carbonate and (B) calcium sulfate obtained with the method according to the present invention.

FIG. 6: FT-IR spectra, comparison between (A) calcium carbonate and (B) calcium sulfate obtained with the method according to the present invention (upper panels) and the respective reference spectra (lower panels).

### DETAILED DESCRIPTION

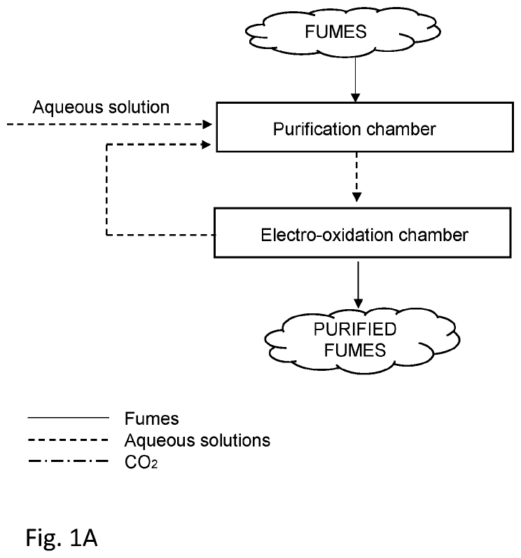

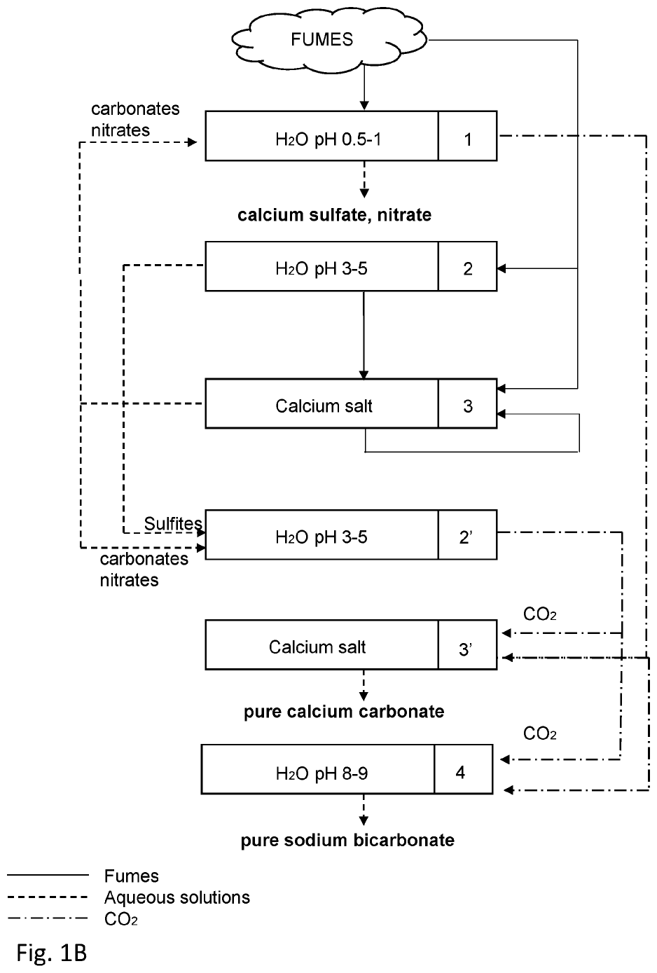

The present invention first relates to a method for the purification of fumes containing pollutants comprising the following steps, with reference to the diagram in FIG. 1A:
Provision of a purification apparatus comprising a purification chamber;
Supply of the fumes to be purified into said purification chamber;
Delivery of an aqueous solution inside said purification chamber;
Recovery of said aqueous solution and electro-oxidation thereof with titanium and/or graphite electrodes;
Recovery of said aqueous solution after electro-oxidation and, optionally, re-circulation thereof;
Recovery of the purified fumes.

Conveniently, said aqueous solution delivered in said purification chamber intercepts the fumes to be purified for the abatement of the organic and/or inorganic compounds present therein.

In an embodiment, said fumes to be purified, before entering said purification chamber, pass through a heat exchanger, for the recovery of excess heat.

In an embodiment, the heat generated in said electro-oxidation step is also conveniently recovered.

In an embodiment, during said electro-oxidation step, in the strongly acidic environment which is created for the solubilization of SO₃ in water and the formation of H₂SO₄, at a pH in the range 0.5-1, the oxidizing power of the system increases, causing the oxidation of metals which precipitate as oxides, of soluble CODs (chemical oxygen demand), of organic substances, with formation of CO₂, and the oxidation of nitrogenous substances in N₂. This process is particularly useful for oxidizing hazardous organic molecules such as, by way of example, VOCs, BTEX, IPA, aniline.

Where the fumes to be treated do not have high levels of SOx, said pollutants are conveniently removed, delivering an acidic aqueous solution into the purification chamber and/or prolonging the residence time of said aqueous solution in said electro-oxidation step.

In an embodiment, said aqueous solution is water.

In an embodiment, said aqueous solution is atomized inside said purification chamber.

The water used for said atomization in said purification chamber is conveniently re-introduced into said purification chamber after said electro-oxidation step.

During the method, said solubilization of SO₃ in water leads to an increase in the density of the solution. Conveniently, when said density exceeds values in the range of 1.2-1.3 kg/m³, said water leaving said electro-oxidation step is not re-circulated but is preferably used as an aqueous solution at pH between 0.5 and 1 in the subsequent recovery and reconversion steps. In said purification chamber, the volume of water is then reconstituted with fresh water.

In an embodiment, said method also comprises the recovery and reconversion of sulfur oxides and/or nitrogen oxides, and/or carbon dioxide contained in said fumes.

In this embodiment the fumes comprising the pollutants, before or after the treatment in said purification apparatus, are passed in one or more aqueous solutions. Partially treated fumes and/or aqueous solutions in which reaction products are precipitated and/or dissolved are obtained from each of said passages in aqueous solution.

Said aqueous solutions are selected from the group comprising:
solution with an acid pH, between 0.5-1;
solution at a pH between 3 and 5, at about pH 4;
Ca(OH)₂ solution at a pH greater than 10;
CaCl₂ solution at a pH less than 10
calcium acetate solution;
solution at a pH between 8 and 9.

Said method comprises the passage in one or more of said aqueous solutions; optionally, said partially treated fumes and/or said aqueous solutions pass in a same aqueous solution more than once.

The reactions occurring in said passages are exothermic reactions under kinetic rather than thermodynamic control and lead to instantaneously obtaining high-purity PCCs and/or high-purity sodium bicarbonate and/or calcium sulfate and/or calcium bisulfite and/or calcium nitrate.

Advantageously, said passages occur in reactors referred to as traps. Advantageously, said traps further comprise a layer 21 of filling bodies 22 with random geometries, made by way of example of ceramic, PP, PVC. Advantageously, said layer of filling bodies slows down the flow, allowing greater contact with water, breaking a preferential flow of the gas, forcing it into a zig-zag path.

In an embodiment, with the aim of recovering the sulfur oxides by converting them into bisulfites, said fumes, before or after being exposed to said purification method, are introduced into an aqueous solution, referred to as an acidic trap, which is water at a pH between 0.5 and 1, which allows the passage in SO₃ solution and/or in an aqueous solution, referred to as a desulfurization trap, which is water at a pH between 3 and 5, which allows the passage in SO₂ solution.

In an embodiment, with the aim of recovering nitrogen oxides and/or CO₂ for subsequent uses or converting it to carbonate, said fumes, before or after being exposed to said purification method, are introduced into an aqueous solution, referred to as a calcium trap, which is alternatively chosen from a Ca(OH)₂ solution, a CaCl₂ solution, a calcium acetate solution, coming to precipitate the carbonates and/or bring nitrates into solution.

Optionally, said solution in which the nitrates are dissolved and/or the carbonates are precipitated is passed in an acidic aqueous solution, at a pH between 0.5 and 5, thus leading to the formation of pure CO₂, available for example for food uses.

In a preferred form, said method comprises one or more of the steps diagrammed in the flowchart in FIG. 1B.

In said embodiment, the fumes to be treated, before or after being exposed to the purification method, are introduced into an aqueous solution at a pH between 0.5 and 1, said acidic trap 1 and/or into an aqueous solution, said desulfurization trap 2, which is water at a pH between 3 and 5, and/or into an aqueous solution, said calcium trap 3, which is alternatively chosen from a Ca(OH)₂ solution, a CaCl₂ solution, a calcium acetate solution.

In the passage in said acidic trap 1, SO₃ contained in said fumes reacts, forming soluble sulfates H₂SO₄. Said aqueous solution in which said bisulfites are dissolved and said pretreated fumes are optionally exposed to subsequent steps.

In the passage in said desulfurization trap 2, SO₂ contained in said fumes reacts, forming soluble bisulfites HSO₃⁻. Said aqueous solution in which said bisulfites are dissolved and said pretreated fumes are optionally exposed to subsequent steps.

With the aim of recovering carbonates and nitrates, said fumes and/or said fumes pretreated in said desulfurization trap 2 pass into said calcium trap 3.

In the passage in said calcium trap 3, the CO₂ contained in said fumes, not soluble in the acidic environments encountered in the previous steps of the method, reacts with the calcium salts present in said solution and precipitates instantly, giving rise to calcium carbonate with impurities. In the same calcium trap 3, the nitrogen oxides also pass in the aqueous solution in the form of nitrates. Said aqueous solution comprising said carbonates and nitrates and said pre-treated fumes are optionally exposed to subsequent steps.

For a complete recovery of the CO₂, the pre-treated fumes exiting said calcium trap 3 are optionally re-conveyed into the same calcium trap 3.

Carbonates and nitrates from said calcium trap 3 are conveyed into an acidic aqueous solution, at a pH between 0.5 and 1, referred to as the acidic trap 1, in which gypsum is formed, CaSO₄×2(H₂O). The CO₂ generated in the method is conveniently recovered for subsequent uses. The nitrates remain in solution.

In addition, or alternatively, carbonates and nitrates from said calcium trap 3 are conveyed into a further desulfurization trap, desulfurization trap 2′, in which the bisulfites obtained in the first step are also conveniently introduced into said aqueous solution at a pH between 3 and 5. The reaction leads to the precipitation of sulfites, conveniently recovered for later uses. The nitrates remain in solution.

Optionally, the CO₂ generated by the passages in said acidic solution and in said desulfurization trap is conveyed into a further calcium solution, calcium trap 3′. The CO₂ thus obtained is pure, leading to calcium carbonate with a high degree of purity. The nitrates remain in solution.

Optionally, the CO₂ generated by the passages in said acidic solution and in said desulfurization trap is conveyed into an alkaline solution, at a pH between 8 and 9, referred to as the alkaline trap 4. In an alkaline environment, the pure CO₂ which is introduced reacts to give bicarbonate with a high degree of purity. The nitrates remain in solution.

In an embodiment, with reference to FIG. 1C, the fumes to be purified and from which to reconvert the oxides and carbon dioxide, after passing in a heat exchanger for the recovery of the heat thereof, are introduced into a first acidic trap, which is an aqueous solution at a pH between 0.5 and 1, preferably at a pH of about 1.

In said first trap, SO₃ passes into solution, giving rise to sulfates. When the concentration thereof increases, and it is possible to verify the concentration by measuring the density of the solution contained in said first trap, said solution passes into a reactor 1 where the addition of calcium carbonate, at controlled T and pH, leads to the formation of gypsum which precipitates, releasing CO₂. The CO₂ thus obtained is pure CO₂, deriving from said reaction; therefore, it is sent directly to CO₂ storage drums.

The volume of said aqueous solution in said first trap is conveniently maintained with the addition of fresh water, at the passage of water loaded in sulfates in said reactor 1.

From the first trap, the fumes pass into a second trap, which is said desulfurization trap, at a pH between 3 and 5, preferably at a pH of 4. The desulfurization trap brings SO₂ into solution, everything which is not SO₂ passes to the next step. In a preferred form, the desulfurized fumes pass through an adsorber, CO₂ desorber, from which the pure CO₂ is passed into CO₂ storage drums.

Said CO₂ adsorber/desorber is conveniently positioned so as to reduce the volume of fumes to be treated, and to use simpler plants. By way of example, the operating conditions include an entry of about 40,000 m³/h of gas into the plant. By virtue of the CO₂ adsorber/desorber, the following method manages reduced volumes, having reduced the volumes of fumes to be treated to the volume of CO₂ alone.

Said CO₂ is introduced into a calcium trap (reactor 3) resulting in the formation of calcium carbonate, which is introduced into a calcium carbonate storage container. The subsequent filtration of this solution allows the recovery of pure calcium carbonate and the recovery of water which can be conveniently re-introduced into the system.

When the concentration of said SO₂ increases in said second trap, said solution is passed into a reactor 2 where, at controlled T and pH, the addition of calcium carbonate leads to the formation of sulfites, which precipitate and are conveniently recovered, freeing CO₂. The CO₂ thus obtained is pure CO₂, deriving from said reaction; therefore, it is sent directly to the CO₂ storage drums.

Conveniently, said reactors use part of the calcium carbonate which is a product obtained from the reconversion to neutralize the sulfuric acid and sodium bisulfite, producing, by virtue of the low pH, CO₂. This allows an additional step of CO₂ purification, and the precipitation of Salts of commercial value such as gypsum and calcium sulfite. Moreover, it allows the recovery of calcium nitrate.

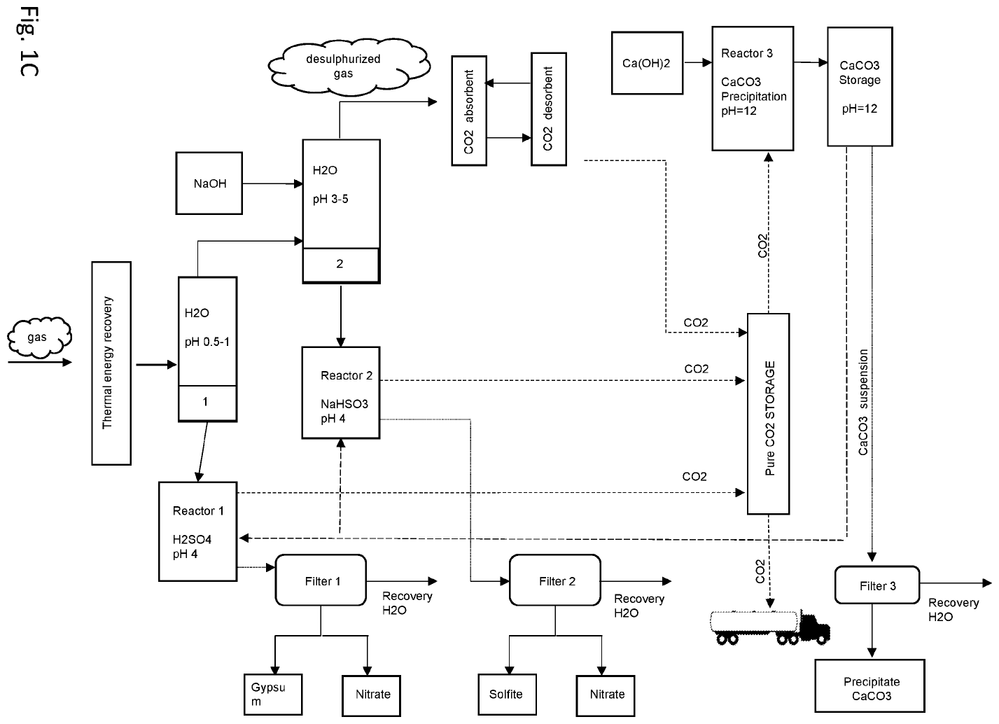

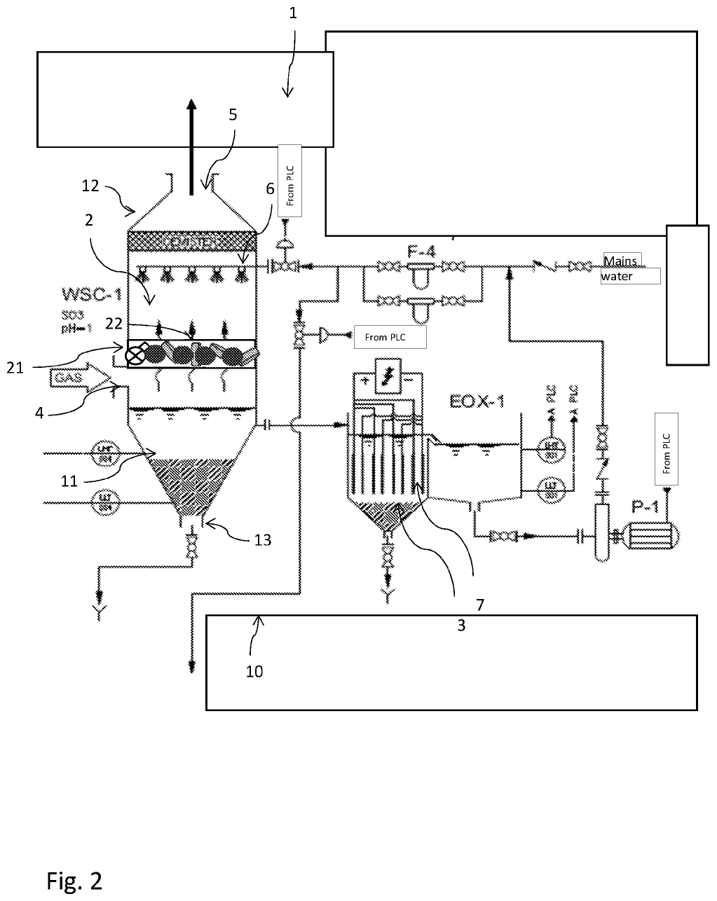

The present invention further relates to a plant for the purification of industrial exhaust fumes, which comprise pollutants, said plant comprising, with reference to FIG. 2:
a purification apparatus 1 comprising a double purification chamber 10, consisting of at least a first hollow body 2 and a second hollow body 3, in fluid connection with each other where
   said first hollow body 2 comprises a lower water collection sector 11, an upper sector 12, an outlet port 13 placed on the bottom of said lower section, where said outlet port 13, in operating conditions, is located below the level of the water occupying said lower sector, an inlet mouth 4 of the fumes to be purified, an outlet mouth 5 of the purified fumes, located at the top of said upper section 12;
   said second hollow body 3 comprises titanium and/or graphite electrodes.

In an embodiment, said first hollow body 2 of said purification chamber 10 is a Demister.

In an embodiment, said first hollow body 2 of said purification chamber 10 further comprises a layer 21 of filling bodies 22 with random geometries, made by way of example of ceramic, PP, PVC. Advantageously, said layer of filling bodies slows down the flow, allowing greater contact with water, breaking a preferential flow of the gas, forcing it into a zig-zag path.

Said first hollow body 2 further comprises nozzles 6 therein, for atomizing an aqueous solution therein.

Pumps P-1 are conveniently positioned to allow the necessary flow of fluids.

In an embodiment, a plant for the recovery and reconversion of sulfur oxides and/or nitrogen oxides, and/or carbon dioxide contained in industrial exhaust fumes is claimed, said plant comprising at least one, or two, or three, or four, or five, or six, or seven trap reactors, where said trap reactors are independently in fluid communication with one another, where “are independently in fluid communication with one another” means that some trap reactors are in fluid connection with one or more further trap reactors, said connections generating a network. Said fluid connections are understood as connections for conveying aqueous solutions from one trap reactor to the next, or for conveying fumes from one trap reactor to the next.

Each of said one or more trap reactors comprises a lower sector conveniently filled with an aqueous solution selected from the group comprising:
solution with an acid pH, between 0.5-1, acidic trap reactor;
solution at a pH between 3 and 5, at about pH 4, desulfurization trap reactor;
Ca(OH)₂ solution, calcium trap reactor;
CaCl₂ solution, calcium trap reactor;
calcium acetate solution, calcium trap reactor;
solution at a pH between 8 and 9, alkaline trap reactor.

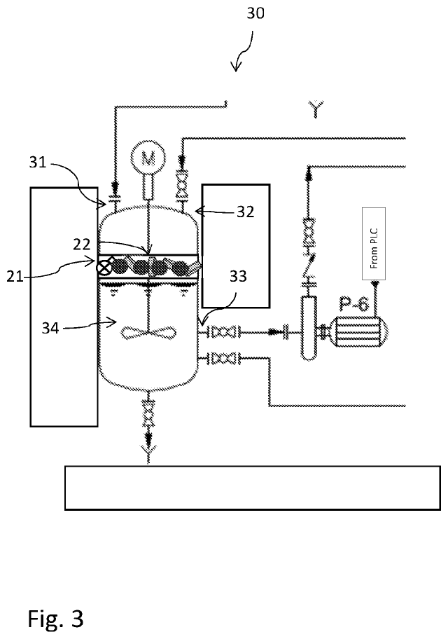

Said one or more trap reactors 30, with reference to FIG. 3, comprise at least one inlet port 31 for said fumes and/or at least one inlet port 32 for said aqueous solutions; optionally, at least one outlet port for said treated fumes and at least one exhaust port 33 opening onto said lower sector 34. A pump P-6 is conveniently used to manage the flows.

In an embodiment, one or more of said trap reactors are Demisters.

In an embodiment, said plant comprises a calcium trap reactor and, downstream thereof, an acidic trap reactor.

In an embodiment, said plant comprises a desulfurization trap reactor, an acidic trap reactor, a calcium trap reactor.

In an embodiment, said plant comprises two desulfurization trap reactors, one acidic trap reactor, two calcium trap reactors.

In an embodiment, said plant comprises two desulfurization trap reactors, an acidic trap reactor, two calcium trap reactors and an alkaline trap reactor.

In an embodiment, said first desulfurization trap reactor is in downstream fluid connection with said second desulfurization trap reactor, with said first calcium trap reactor and, optionally, with said alkaline trap reactor.

In an embodiment, said first calcium trap reactor is in downstream fluid connection with said second desulfurization trap reactor and with said acidic trap reactor.

In an embodiment, said acidic trap reactor is in downstream fluid connection with said second calcium trap reactor and, optionally, with said alkaline trap reactor.

In an embodiment, there are sensors on some or all of the inlet and/or outlet ports of said trap reactors.

By way of example, and with reference to the first calcium trap reactor, said fumes exiting said calcium trap reactor are re-conveyed into the same calcium trap reactor only when a sensor detects amounts of CO₂ above a defined threshold value.

In an embodiment, the present invention relates to a plant comprising:
a plant for the purification of industrial exhaust fumes;
a plant for the recovery and reconversion of sulfur oxides and/or nitrogen oxides, and/or carbon dioxide contained in the same fumes.

In an embodiment, said plant comprises:
a purification apparatus 1 comprising a double purification chamber, consisting of at least a first hollow body 2 and a second hollow body 3, in fluid connection with each other, where
   said first hollow body 2 comprises a lower water collection sector, an upper sector, an outlet port 13 placed at the bottom of said lower section, an inlet mouth 4 of the fumes to be purified, an outlet mouth 5 of the purified fumes, located at the top of said upper section 12;
   second hollow body 3 comprises titanium and/or graphite electrodes.
a reconversion apparatus, comprising at least an acidic trap, a desulfurization trap, a calcium trap.

The active ingredients that the method according to the present invention allows to recover from the exhaust ports of said trap reactors are dissolved or suspended in water. In an embodiment, said active ingredients are conveniently recovered, after any precipitation, with filtration according to the prior art. In an embodiment, said filtrates are dried so as to provide said powdered active ingredients.

Conveniently, said drying occurs using the heat recovered from the fumes before and during the purification treatment, by means of a heat exchanger.

After said filtration, the water is recovered and can be re-introduced in the method.

The plant and method according to the present invention, in the different embodiments thereof, offer considerable advantages, providing a new method, where industrial waste products which are not only low cost but polluting and which are associated with costs related to proper disposal are used as starting material, also reducing highly energy-intensive processes typically necessary for the production of raw materials such as high-purity calcium carbonate.

The plant and method according to the present invention conveniently allow purifying industrial exhaust fumes, leading to the introduction into the environment of a smoke which is free of polluting components, containing mainly oxygen, as well as obtaining a convenient reuse of nitrates, sulfites and calcium sulfate.

For example, said nitrates are conveniently used in agriculture, for example in the production of fertilizers.

Moreover, said calcium sulfate is used in construction to make plaster. In agriculture, it is used as a fertilizer capable of yielding calcium to roots. It also finds useful use in the correction of alkaline soils and increases the entry of air and water into the ground. In the food industry, where it is known as E516, it is used in the treatment of flours. In medicine, calcium sulfate is used as an excipient in the production of tablets; in dentistry it serves as a base for making dental impressions, prostheses and restorations.

Said calcium carbonate lacking impurities forms a valuable raw material. In fact, the calcium carbonate thus precipitated is a very fine white powder which is used in cosmetics as a filler, improves the adhesion of powders, modulates the density and has the ability to absorb water. Moreover, having a high degree of purity, it can be used to obtain CO₂ for food use.

The following examples have the sole purpose of better illustrating the invention and are not to be understood as limiting it in any manner, the scope of which is defined by the following claims.

### EXAMPLES

### Example 1: Plant and Method for the Recovery and Reconversion of Sulfur Oxides, Nitrogen Oxides and Carbon Dioxide Contained in Industrial Exhaust Fumes

The fumes to be treated were conveyed to a first reactor which is a desulfurization trap reactor.

Said desulfurization trap reactor comprises a lower sector, an inlet port for said fumes, an outlet port for said treated fumes and an exhaust port opening onto said lower sector.

In an embodiment, said desulfurization trap reactor is a Demister.

Water is contained in said lower sector which is brought to a pH between 3 and 5 by the addition of NaOH, an addition necessitated by the heavy acidification occurring in said desulfurization trap for the formation of hydrogen sulfide.

Alternatively, the pH is brought into the range 3-5 by the addition of KOH, thus leading to the formation of KHSO₃. Alternatively, by the addition of Ca(OH)₂, thus leading to the formation of CaSO₃.

In said desulfurization trap reactor, bisulfites are formed which pass into said aqueous solution.

Said aqueous solution in which the formed bisulfites are dissolved is recovered through said exhaust port. The treated fumes exit through said outlet port.

Said fumes exiting said desulfurization trap reactor are conveyed to a second reactor which is a calcium trap reactor.

Said calcium trap reactor comprises a lower sector, an inlet port for said fumes, an outlet port for said treated fumes and one or preferably two exhaust ports opening onto said lower sector.

In an embodiment, said desulfurization trap reactor is a Demister.

In two independent experiments, two different aqueous solutions were used for said calcium trap reactor

In a first experiment, in said lower sector Ca(OH)₂ is contained at a pH greater than 11, conveniently obtained by dissolving CaO in water.

In a second experiment, CaCl₂ is contained in said lower sector, at a pH less than 10.

In both cases, carbonates and nitrates are precipitated in said calcium trap reactors and pass into said aqueous solution.

Said aqueous solution comprising carbonates and nitrates is recovered through one of said exhaust ports. The treated fumes exit through said outlet port.

In an embodiment, carbonates and nitrates recovered from one of said open exhaust ports on said calcium trap reactor are conveyed into a buffer reactor acting as a reservoir.

Said carbonates and nitrates exiting said calcium trap reactor are conveyed into a reactor which is an acidic trap reactor.

Said acidic trap reactor comprises a lower sector, two inlet ports and one outlet port.

In said lower sector, water is contained at a pH between 0.5-1. Conveniently, said acidic water is water recovered from the purification method, where the dissolution of SO₃ has led to the formation of H₂SO₄.

Calcium sulfate and nitrates are formed in said acidic trap reactor and are conveniently recovered. The calcium sulfate thus obtained was characterized; the results are reported in example 2 below.

In an embodiment, the plant comprises a further desulfurization trap reactor. In this second desulfurization trap reactor, which has the features already described for the desulfurization trap reactor, the aqueous bisulfite solution is conveyed out of the exhaust port of said first desulfurization trap reactor, which is water which has reached the density of 1.2-1.3 and the carbonates and nitrates exiting the exhaust port of the calcium trap reactor, or from the buffer reactor. In this further desulfurization trap reactor the carbonates react with the bisulfites, forming calcium sulfite and CO₂.

The nitrates, which are soluble in water, do not pollute the powders which precipitate. Conveniently, said nitrates are recovered when they have reached a significant concentration in water.

In an embodiment, the plant comprises a further calcium trap reactor. In this second calcium trap reactor, CO₂ is conveyed out of the exhaust port of said acidic trap reactor and/or said second desulfurization trap reactor.

Said CO₂ is pure CO₂ which, when introduced into the further calcium trap reactor, leads to the precipitation of calcium carbonate lacking impurities. The calcium carbonate obtained using the calcium trap referred to in experiment 1 or experiment 2 was characterized. The results are shown in example 2.

In an embodiment, the plant comprises an alkaline trap reactor. An aqueous solution at a pH between 8 and 9 is contained in this alkaline trap reactor. In a preferred form, said pH is maintained with the addition of NaOH, alternatively with the addition of KOH. In said alkaline trap reactor, CO₂ is conveyed out of the exhaust port of said acidic trap reactor and/or said second desulfurization trap reactor. In this alkaline trap reactor, sodium bicarbonate, or potassium bicarbonate, is formed, with high purity.

The aqueous solutions recovered by said plant, comprising calcium sulfate, high-purity calcium carbonate, high-purity bicarbonate, are filtered and the powders dried.

The nitrates in solution are also conveniently recovered.

The plant and the method implemented therewith have surprisingly allowed obtaining high-purity calcium carbonate, high-purity bicarbonate, nitrates from industrial exhaust fumes, with exothermic reactions.

### Example 2: Analysis of Calcium Carbonate and Calcium Sulfate Obtained with the Method According to the Present Invention

Samples of calcium carbonate obtained as in example 1, precipitating from Ca(OH)₂, at pH greater than 11 or from CaCl₂, at pH less than 10 and samples of calcium sulfate obtained as in example 1 were analyzed under scanning electron microscope.

As for calcium carbonate, the results obtained show that as a function of the calcium salt used for the precipitation, there is a morphological and dimensional control of the particles obtained.

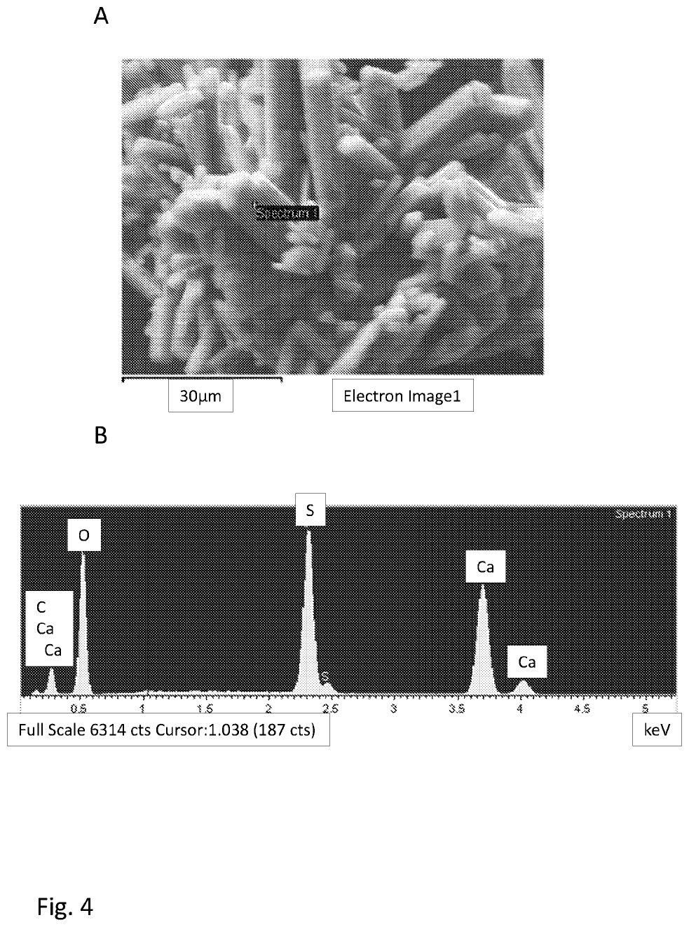

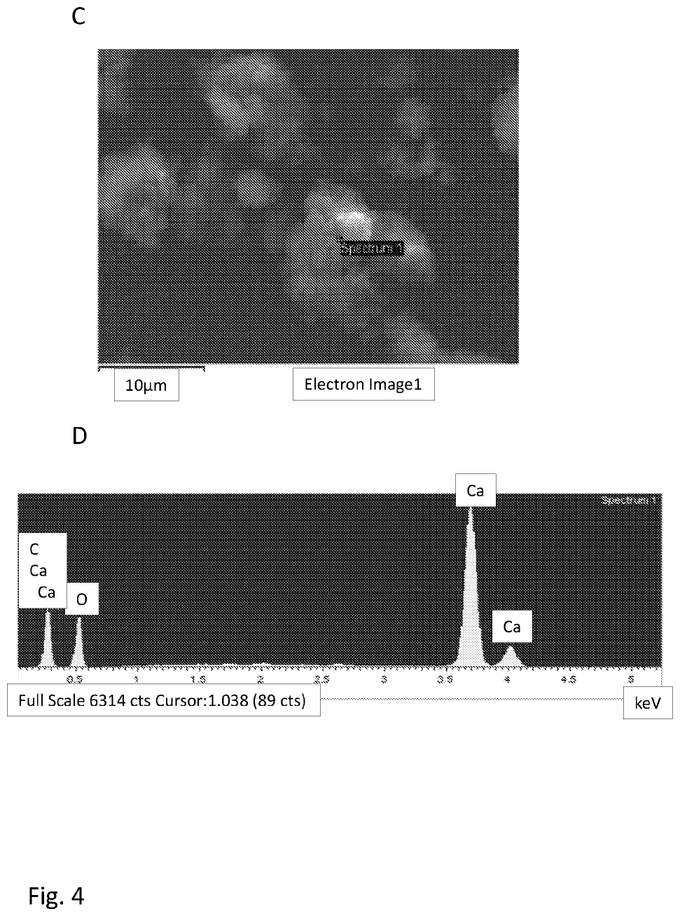

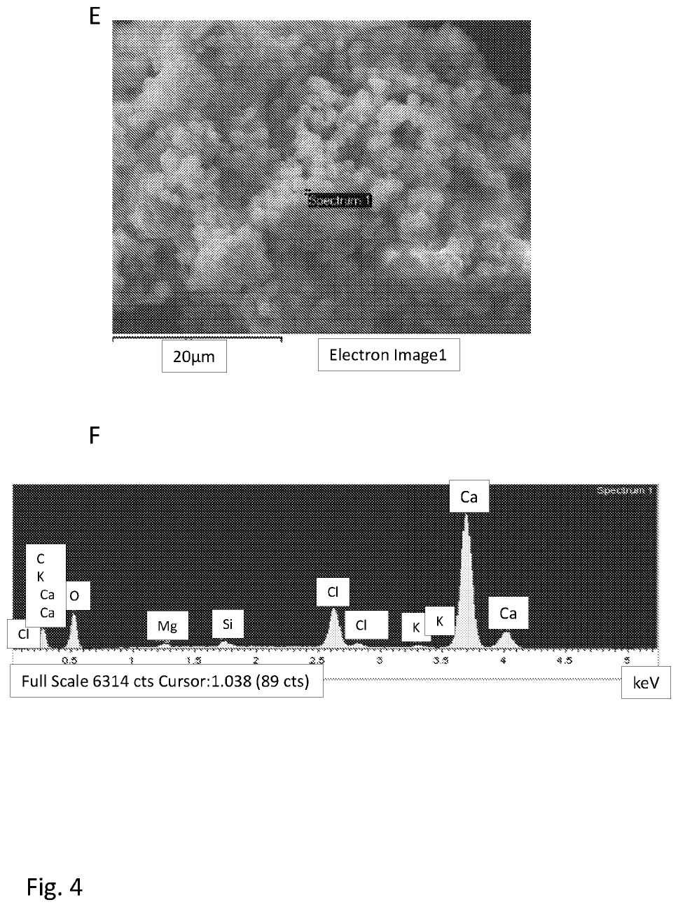

FIG. 4A shows that the calcium sulfate particles obtained by precipitating them in acid solution are mutually homogeneous, with a regular rod morphology.

The spectrum obtained with EDS microanalysis (4B) shows the high degree of purity obtained.

FIG. 4C shows that the calcium carbonate particles obtained by precipitating in Ca(OH)₂ have a regular and homogeneous morphology.

The spectrum obtained with EDS microanalysis (4D) shows the high degree of purity obtained.

FIG. 4E shows that the calcium carbonate particles obtained by precipitating from CaCl₂) have a regular morphology with homogeneous spheres, which favors the glidant properties thereof.

The spectrum obtained with EDS microanalysis (4F) shows the high degree of purity obtained for this sample as well.

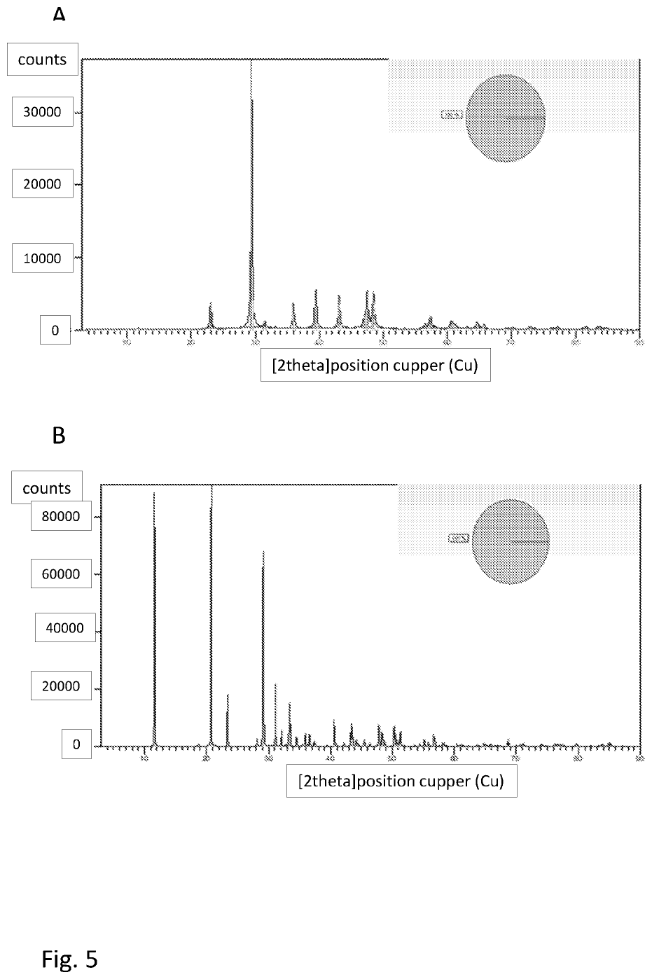

The structure of calcium carbonate samples obtained by precipitating from Ca(OH)₂ and calcium sulfate samples was analyzed by means of X rays. The spectra obtained are shown in FIG. 5A and FIG. 5B, respectively, where the few characteristic peaks of said elements are well identifiable.

The list of peaks is given in tables 1 and 2, respectively.

TABLE 1
peaks from X-ray diffraction analysis of calcium carbonate
obtained by precipitating from Ca(OH)2 with the method
according to the present invention.

| Pos. | Height | FWHM | d-spacing | Rel. |
|---|---|---|---|---|
| [°2Th.] | [cts] | [°2Th.] | [Å] | Int. [%] |
| 11.6374 | 81.08 | 0.1181 | 7.60432 | 0.22 |
| 23.0298 | 3531.56 | 0.1378 | 3.86198 | 9.68 |
| 29.3897 | 36489.01 | 0.1771 | 3.03912 | 100.00 |
| 31.4707 | 820.53 | 0.1968 | 2.84275 | 2.25 |
| 33.1584 | 92.81 | 0.2755 | 2.70181 | 0.25 |
| 35.9066 | 3238.17 | 0.2362 | 2.50108 | 8.87 |
| 39.3904 | 5150.58 | 0.1771 | 2.28754 | 14.12 |
| 43.1040 | 4175.34 | 0.1920 | 2.09694 | 11.44 |
| 43.2213 | 3502.48 | 0.0960 | 2.09671 | 9.60 |
| 47.0531 | 1683.59 | 0.2400 | 1.92973 | 4.61 |
| 47.4905 | 4851.57 | 0.1680 | 1.91297 | 13.30 |
| 48.4799 | 4790.41 | 0.2160 | 1.87622 | 13.13 |
| 48.6182 | 3540.42 | 0.0960 | 1.87586 | 9.70 |
| 56.4848 | 582.91 | 0.1920 | 1.62784 | 1.60 |
| 57.3433 | 1559.61 | 0.3120 | 1.60549 | 4.27 |
| 58.0729 | 237.31 | 0.2880 | 1.58705 | 0.65 |
| 60.5875 | 965.87 | 0.1680 | 1.52706 | 2.65 |
| 61.3648 | 507.32 | 0.2880 | 1.50957 | 1.39 |
| 63.0447 | 281.98 | 0.2880 | 1.47332 | 0.77 |
| 64.5870 | 834.93 | 0.2880 | 1.44181 | 2.29 |
| 65.6141 | 521.79 | 0.2400 | 1.42171 | 1.43 |
| 69.1399 | 129.09 | 0.3840 | 1.35757 | 0.35 |
| 70.2084 | 238.42 | 0.2400 | 1.33950 | 0.65 |
| 72.7907 | 341.66 | 0.4320 | 1.29821 | 0.94 |
| 76.1588 | 97.81 | 0.3840 | 1.24896 | 0.27 |
| 77.1392 | 236.94 | 0.3360 | 1.23551 | 0.65 |
| 81.5121 | 224.76 | 0.5760 | 1.17992 | 0.62 |
| 83.5181 | 241.22 | 0.3840 | 1.15661 | 0.66 |
| 84.7279 | 136.64 | 0.4800 | 1.14315 | 0.37 |

TABLE 2
Peaks from X-ray diffraction analysis of calcium sulfate exiting the
acidic trap with the method according to the present invention.

| Pos. | Height | FWHM | d-spacing | Rel. |
|---|---|---|---|---|
| [°2Th.] | [cts] | [°2Th.] | [Å] | Int. [%] |
| 11.6388 | 88287.10 | 0.0787 | 7.60341 | 96.71 |
| 18.6983 | 801.64 | 0.0787 | 4.74568 | 0.88 |
| 20.0152 | 214.56 | 0.0590 | 4.43630 | 0.24 |
| 20.7223 | 91293.02 | 0.0984 | 4.28650 | 100.00 |
| 23.3785 | 17957.61 | 0.0984 | 3.80515 | 19.67 |
| 28.0986 | 2350.35 | 0.0984 | 3.17576 | 2.57 |
| 29.0928 | 65557.69 | 0.0984 | 3.06945 | 71.81 |
| 31.0881 | 20063.16 | 0.0960 | 2.87448 | 21.98 |
| 31.1894 | 9736.85 | 0.0480 | 2.87249 | 10.67 |
| 31.7135 | 85.81 | 0.1440 | 2.81920 | 0.09 |
| 32.0661 | 5120.31 | 0.0960 | 2.78900 | 5.61 |
| 32.7390 | 514.01 | 0.0960 | 2.73320 | 0.56 |
| 33.3442 | 14254.82 | 0.0960 | 2.68496 | 15.61 |
| 34.4876 | 3095.97 | 0.0720 | 2.59851 | 3.39 |
| 34.5896 | 2529.68 | 0.0720 | 2.59109 | 2.77 |
| 35.3739 | 579.87 | 0.0720 | 2.53541 | 0.64 |
| 35.9436 | 4249.97 | 0.0720 | 2.49652 | 4.66 |
| 36.0574 | 1958.50 | 0.0480 | 2.49509 | 2.15 |
| 36.2568 | 741.21 | 0.0720 | 2.47567 | 0.81 |
| 36.5874 | 3921.84 | 0.0720 | 2.45406 | 4.30 |
| 36.7012 | 1801.66 | 0.0480 | 2.45279 | 1.97 |
| 37.3609 | 1715.10 | 0.0960 | 2.40500 | 1.88 |
| 37.4748 | 845.07 | 0.0480 | 2.40392 | 0.93 |
| 39.3042 | 312.45 | 0.0960 | 2.29045 | 0.34 |
| 40.6173 | 8691.48 | 0.0720 | 2.21939 | 9.52 |
| 40.7404 | 4341.49 | 0.0480 | 2.21846 | 4.76 |
| 42.1510 | 1059.23 | 0.0720 | 2.14211 | 1.16 |
| 43.3187 | 7424.74 | 0.0720 | 2.08704 | 8.13 |
| 43.4442 | 5698.08 | 0.0480 | 2.08647 | 6.24 |
| 43.5918 | 6403.82 | 0.0720 | 2.07459 | 7.01 |
| 43.7226 | 2970.39 | 0.0480 | 2.07383 | 3.25 |
| 44.1819 | 2227.15 | 0.0960 | 2.04824 | 2.44 |
| 44.3117 | 1176.10 | 0.0480 | 2.04762 | 1.29 |
| 44.5466 | 462.60 | 0.0720 | 2.03232 | 0.51 |
| 45.4832 | 2208.91 | 0.0960 | 1.99262 | 2.42 |
| 45.6162 | 1172.27 | 0.0480 | 1.99206 | 1.28 |
| 46.1823 | 207.92 | 0.0720 | 1.96407 | 0.23 |
| 46.4188 | 928.89 | 0.0720 | 1.95461 | 1.02 |
| 47.4549 | 272.37 | 0.0720 | 1.91433 | 0.30 |
| 47.8317 | 7190.03 | 0.0720 | 1.90012 | 7.88 |
| 47.9712 | 3647.79 | 0.0720 | 1.89963 | 4.00 |
| 48.3546 | 4984.21 | 0.0720 | 1.88079 | 5.46 |
| 48.4943 | 2744.50 | 0.0480 | 1.88036 | 3.01 |
| 48.7616 | 1314.12 | 0.0960 | 1.86604 | 1.44 |
| 48.9034 | 595.12 | 0.0720 | 1.86558 | 0.65 |
| 50.2985 | 7000.42 | 0.0960 | 1.81256 | 7.67 |
| 50.4436 | 3645.04 | 0.0720 | 1.81218 | 3.99 |
| 50.6947 | 2045.02 | 0.0720 | 1.79932 | 2.24 |
| 51.1249 | 1799.64 | 0.0720 | 1.78519 | 1.97 |
| 51.3218 | 4790.25 | 0.0960 | 1.77880 | 5.25 |
| 51.4716 | 2353.36 | 0.0720 | 1.77838 | 2.58 |
| 53.5586 | 496.15 | 0.0960 | 1.70967 | 0.54 |
| 53.7118 | 247.09 | 0.0720 | 1.70939 | 0.27 |
| 54.4017 | 1006.50 | 0.0960 | 1.68515 | 1.10 |
| 54.5538 | 467.85 | 0.0960 | 1.68498 | 0.51 |
| 55.1214 | 2253.23 | 0.0960 | 1.66483 | 2.47 |
| 55.2780 | 1142.68 | 0.0960 | 1.66462 | 1.25 |
| 55.8120 | 1347.94 | 0.0720 | 1.64586 | 1.48 |
| 55.9751 | 658.98 | 0.0720 | 1.64553 | 0.72 |
| 56.7209 | 4156.23 | 0.0960 | 1.62162 | 4.55 |
| 56.8856 | 2124.29 | 0.0720 | 1.62134 | 2.33 |
| 57.5313 | 199.06 | 0.0720 | 1.60069 | 0.22 |
| 58.1410 | 954.07 | 0.1200 | 1.58535 | 1.05 |
| 58.3146 | 744.35 | 0.0720 | 1.58497 | 0.82 |
| 58.6365 | 317.60 | 0.0720 | 1.57313 | 0.35 |
| 58.7986 | 131.36 | 0.0960 | 1.57308 | 0.14 |
| 59.5073 | 171.46 | 0.0960 | 1.55217 | 0.19 |
| 60.3234 | 1115.39 | 0.0960 | 1.53311 | 1.22 |
| 60.4945 | 587.15 | 0.0720 | 1.53298 | 0.64 |
| 60.8335 | 446.75 | 0.0960 | 1.52147 | 0.49 |
| 61.0018 | 228.09 | 0.0720 | 1.52145 | 0.25 |
| 61.2331 | 470.70 | 0.0960 | 1.51250 | 0.52 |
| 61.4192 | 306.31 | 0.0960 | 1.51211 | 0.34 |
| 62.0130 | 298.21 | 0.0960 | 1.49533 | 0.33 |
| 62.3806 | 292.87 | 0.1200 | 1.48740 | 0.32 |
| 62.5428 | 111.55 | 0.0960 | 1.48762 | 0.12 |
| 63.7088 | 745.13 | 0.0960 | 1.45956 | 0.82 |
| 63.8848 | 346.66 | 0.0720 | 1.45958 | 0.38 |
| 64.6957 | 984.09 | 0.0960 | 1.43966 | 1.08 |
| 64.8874 | 789.01 | 0.1440 | 1.43586 | 0.86 |
| 65.2841 | 491.24 | 0.0960 | 1.42809 | 0.54 |
| 65.4670 | 262.16 | 0.0720 | 1.42809 | 0.29 |
| 65.7984 | 810.00 | 0.0960 | 1.41817 | 0.89 |
| 65.9842 | 375.34 | 0.0720 | 1.41815 | 0.41 |
| 66.6492 | 488.82 | 0.0960 | 1.40212 | 0.54 |
| 66.8405 | 228.32 | 0.0960 | 1.40205 | 0.25 |
| 67.0940 | 137.86 | 0.0960 | 1.39390 | 0.15 |
| 67.5104 | 218.52 | 0.0960 | 1.38631 | 0.24 |
| 68.6571 | 2414.67 | 0.0960 | 1.36593 | 2.64 |
| 68.8581 | 1219.99 | 0.0960 | 1.36582 | 1.34 |
| 70.0476 | 299.67 | 0.0960 | 1.34218 | 0.33 |
| 70.4404 | 439.25 | 0.0960 | 1.33565 | 0.48 |
| 70.6296 | 641.63 | 0.0960 | 1.33254 | 0.70 |
| 70.8351 | 351.56 | 0.0720 | 1.33248 | 0.39 |
| 71.0020 | 629.95 | 0.0960 | 1.32646 | 0.69 |
| 71.1883 | 947.84 | 0.0960 | 1.32345 | 1.04 |
| 71.3884 | 346.75 | 0.0960 | 1.32351 | 0.38 |
| 72.9981 | 14.19 | 0.2880 | 1.29504 | 0.02 |
| 74.0807 | 742.10 | 0.0960 | 1.27877 | 0.81 |
| 74.3001 | 384.89 | 0.0960 | 1.27870 | 0.42 |
| 74.8497 | 302.67 | 0.0960 | 1.26752 | 0.33 |
| 75.9738 | 237.96 | 0.0960 | 1.25154 | 0.26 |
| 76.2025 | 795.79 | 0.0960 | 1.24835 | 0.87 |
| 76.4832 | 649.68 | 0.1440 | 1.24447 | 0.71 |
| 76.8045 | 574.71 | 0.1200 | 1.24314 | 0.63 |
| 77.0103 | 400.95 | 0.0960 | 1.23726 | 0.44 |
| 77.2453 | 378.48 | 0.0960 | 1.23408 | 0.41 |
| 77.4562 | 576.07 | 0.1200 | 1.23125 | 0.63 |
| 77.6766 | 210.62 | 0.0720 | 1.23135 | 0.23 |
| 79.5653 | 923.22 | 0.0960 | 1.20382 | 1.01 |
| 79.8850 | 324.68 | 0.2400 | 1.19981 | 0.36 |
| 80.3982 | 170.66 | 0.0960 | 1.19344 | 0.19 |
| 81.9245 | 250.68 | 0.1200 | 1.17502 | 0.27 |
| 83.2665 | 416.51 | 0.1200 | 1.15946 | 0.46 |
| 83.5224 | 246.97 | 0.0960 | 1.15943 | 0.27 |
| 83.7572 | 530.81 | 0.0960 | 1.15391 | 0.58 |
| 84.0353 | 235.58 | 0.1440 | 1.15366 | 0.26 |
| 84.5470 | 144.56 | 0.0960 | 1.14514 | 0.16 |
| 84.8590 | 1223.07 | 0.1200 | 1.14172 | 1.34 |
| 85.1292 | 1069.82 | 0.1200 | 1.13879 | 1.17 |
| 85.3883 | 329.19 | 0.1440 | 1.13882 | 0.36 |
| 85.9429 | 154.45 | 0.1200 | 1.13008 | 0.17 |
| 86.9399 | 213.55 | 0.1440 | 1.11966 | 0.23 |
| 87.2144 | 80.68 | 0.1440 | 1.11962 | 0.09 |

Lastly, the FT-IR spectra were obtained for the same samples of calcium carbonate and calcium sulfate, so as to study the structure thereof.

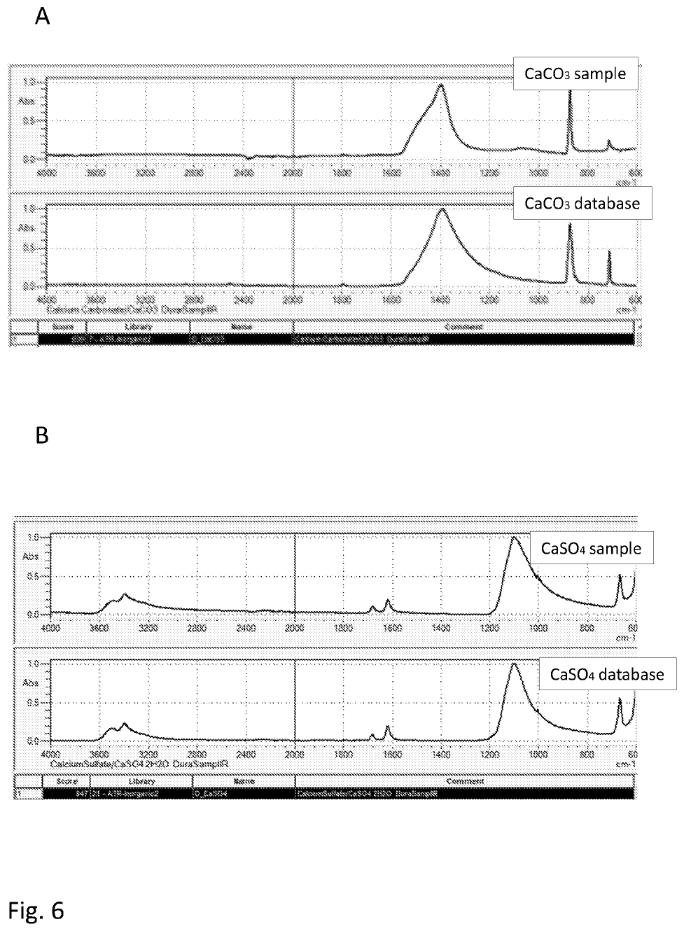

The results are shown in FIG. 6, panels A and B.

In both cases, the comparison was made with the spectra of the substances as present in the database. The comparison clearly shows that the precipitates obtained from the method are exactly the indicated compounds.

### Example 3: Thermal Energy Recovery

Table 3 below shows the KW recovered by passing the fumes emitted by a chimney at 110° C. through a heat exchanger.

TABLE 3
Energy recovery (heat)

| | | |
|---|---|---|
| Inlet flue gas temperature | 110 | ° C. |
| Outlet flue gas temperature | 35 | ° C. |
| Average specific heat by weight | 0.241 | Kcal/Kg C. |
| Density of the gas | 0.963 | Kg/m3 |
| average specific heat with respect to volume | 0.232 | Kcal/m3 C. |
| Energy recovered (hourly) | 617921 | Kcal/h |
| KJ recovered | 2570551 | KJ/h |
| KW per hour recovered | 742 | Kw |

In the exemplified case, 400 KW/h recovered are used for the operation of the CO₂ desorption column, the remainder to promote the drying of the crystals formed downstream of the plant reactors.

### Example 4: Passage in the Purification Chamber

Table 4 shows the gas reaction data in the purification chamber. In the situation shown, only SO₃ and Nox are soluble, while SO₂ and CO₂ remain insoluble and pass to the next desulfurization trap. The absorption of SO₃ in water is thermodynamically favored, as apparent from the deltaG and log(K).

TABLE 4

| | | | | | |
|---|---|---|---|---|---|
| | deltaH | deltaS | deltaG | | |
| TC | kcal | cal/K | kcal | K | Log(K) |

SO₃(g) + H₂O = H₂SO₄

| | | | | | |
|---|---|---|---|---|---|
| 35,000 | −31,611 | −40,481 | −19,136 | 3,744E+013 | 13,573 |

SO₃(g) + H₂O = H₂SO4

| | | | | | |
|---|---|---|---|---|---|
| 35,000 | −31,611 | −40,481 | −19,136 | 3,744E+013 | 13,573 |

CO₂(g) + H₂O = H₂CO₃(a)

| | | | | | |
|---|---|---|---|---|---|
| 35,000 | −5,144 | −23,899 | 2,220 | 2,662E−002 | −1,575 |

When the density of the solution in the purification chamber reaches 1.2-1.3 g/cm³, it is subjected to electro-oxidation treatment, so as to oxidize organic and inorganic substances, such as heavy metals.

### Example 5: Passage in the Desulfurization Trap

In the desulfurization trap, operating at 35° C. at pH 4, only SO₂ is soluble, and the presence of sodium makes the absorption in water thermodynamically favorable, as shown in table 5 below.

TABLE 5
SO₂ (g) + 2NaOH = Na₂SO₃ + H₂O

| | deltaH | deltaS | deltaG | | |
|---|---|---|---|---|---|
| TC | kcal | cal/K | kcal | K | Log(K) |
| 35,000 | −55,453 | −38,227 | −43,673 | 9,486E+030 | 30,977 |

The CO₂ remains insoluble due to the acidic pH and remains in the fumes which pass to the CO₂ absorption treatment.

When the density of the aqueous solution in the desulfurization trap reaches 1.1 g/cm³, the solution is passed into reactor 2 where, with the addition of calcium carbonate, the sulfites precipitate, with the release of CO₂. The reaction parameters are summarized in Table 5bis.

TABLE 5bis
Ca(OH)₂ + CO₂ (g) = CaCO₃ + H₂O

| | deltaH | deltaS | deltaG | | |
|---|---|---|---|---|---|
| TC | kcal | cal/K | kcal | K | Log(K) |
| 35,000 | −26,932 | −32,117 | −17,035 | 1,209E+012 | 12,083 |

| | FM | Conc. | Amount | Amount | Volume |
|---|---|---|---|---|---|
| Formula | g/mol | wt-% | mol | g | l or ml |
| Ca(OH)₂ | 74,095 | 62,737 | 1,000 | 74,095 | 33,078 ml |
| CO₂(g) | 44,010 | 37,263 | 1,000 | 44,010 | 22,414 l |
| CaCO₃ | 100,089 | 84,746 | 1,000 | 100,089 | 36,933 ml |
| H₂O | 18,015 | 15,254 | 1,000 | 18,015 | 19,646 ml |

### Example 6: CO₂ Absorbent/Desorbent

The CO₂ present in the fumes exiting the desulfurization trap is adsorbed by a 20% potassium carbonate solution in the adsorption column. The carbonate is transformed into potassium bicarbonate at room temperature and pH between 7 and 8. The CO₂ is then released into the desorption column, where the bicarbonate returns to carbonate, working hot (85° C., 0.4 bar). The CO₂ released is stored in storage drums, at 32 bar. The reaction parameters are summarized in table 6.

TABLE 6
1CO₂ (g) + 1K₂CO₃ + 1H₂O = 2KHCO3

| | deltaH | deltaS | deltaG | | |
|---|---|---|---|---|---|
| TC | kcal | cal/K | kcal | K | Log(K) |
| 35,000 | −23,733 | −50,126 | −8,287 | 7,546E+005 | 5,878 |

### Example 7: Calcium Carbonate Precipitation

The collected CO₂ is conveyed into a reactor, where it is diffused in the form of micro-bubbles. There is a 20% sand (lime) suspension at pH 12 therein. Under these conditions, CO₂ is soluble and reacts spontaneously, leading to the precipitation of calcium carbonate. The reaction parameters are summarized in Table 7.

TABLE 7
Ca(OH)₂ + CO₂ (g) = CaCO₃ + H₂O

| | deltaH | deltaS | deltaG | | |
|---|---|---|---|---|---|
| TC | kcal | cal/K | kcal | K | Log(K) |
| 35,000 | −26,932 | −32,117 | −17,035 | 1,209E+012 | 12,083 |

| | FM | Conc. | Amount | Amount | Volume |
|---|---|---|---|---|---|
| Formula | g/mol | wt-% | mol | g | l or ml |
| Ca(OH)2 | 74,095 | 62,737 | 1,000 | 74,095 | 33,078 ml |
| CO2(g) | 44,010 | 37,263 | 1,000 | 44,010 | 22,414 l |
| CaCO3 | 100,089 | 84,746 | 1,000 | 100,089 | 36,933 ml |
| H2O | 18,015 | 15,254 | 1,000 | 18,015 | 19,646 ml |

1. A method for the purification of fumes which recovers and reconverts sulfur oxides and/or nitrogen oxides and/or carbon dioxide contained therein, wherein said method comprises:
Provision of a purification apparatus comprising a purification chamber;
Supply of the fumes to be purified into said purification chamber;
Delivery of an aqueous solution inside said purification chamber;
Recovery of said aqueous solution and electro-oxidation thereof with titanium and/or graphite electrodes;
Recovery of said aqueous solution after electro-oxidation;
Recovery of the purified fumes,
characterized in that said purified fumes are further passed in one or more aqueous solutions,
wherein said aqueous solutions are selected from the group comprising:
solution at acid pH, between 0.5-1, referred to as an acidic trap;
solution at a pH between 3 and 5, at about pH 4, referred to as a desulfurization trap;
Ca(OH)₂ or CaCl₂ or calcium acetate solution, referred to as a calcium trap;
solution at a pH between 8 and 9, referred to as an alkaline trap.

2. A method according to claim 1, wherein said fumes are introduced into said solution at a pH between 3 and 5, the desulfurization trap, with the formation of bisulfites.

3. A method according to claim 1, wherein said fumes are introduced into said Ca(OH)₂ or CaCl₂ or calcium acetate solution, the calcium trap, precipitating the carbonates and/or bringing nitrates into solution.

4. A method according to claim 3, wherein said carbonates precipitated in said passage into said calcium trap solution are conveyed into an acidic aqueous solution, with formation of calcium sulfate and CO₂.

5. A method according to claim 1, wherein said fumes are introduced into said desulfurization trap, obtaining bisulfites, and into said calcium trap, obtaining carbonates and nitrates, said carbonates and said bisulfites being then conveyed into a further desulfurization trap, obtaining pure CO₂.

6. A method according to claim 1, wherein the CO₂ generated in said processes is conveyed into a further calcium trap solution, with precipitation of calcium carbonate with a high degree of purity.

7. A method according to claim 1, wherein the CO₂ generated in said processes is conveyed into said alkaline trap solution, with precipitation of bicarbonate with a high degree of purity.

8. A method according to claim 1, wherein the active ingredients obtained as precipitates in water are filtered.

9. A plant for the purification of industrial exhaust fumes and for the recovery and reconversion of sulfur oxides and/or nitrogen oxides, and/or carbon dioxide contained therein, said plant comprising:
a purification apparatus comprising a double purification chamber, consisting of at least a first hollow body and a second hollow body, in fluid connection with each other; wherein
said first hollow body comprises a lower water collection sector, an upper sector, an outlet port placed at the bottom of said lower section, wherein said outlet port, in operating conditions, is located below the level of the water occupying said lower sector, an inlet mouth of the fumes to be purified, an outlet mouth of the purified fumes, located at the top of said upper section;
said second hollow body comprises titanium and/or graphite electrodes;
at least one, or two, or three, or four, or five, or six, or seven trap reactors, wherein said trap reactors are independently in fluid communication with one another, wherein each of said one or more trap reactors comprises a lower sector conveniently filled with an aqueous solution, at least one inlet port for said fumes and/or at least one inlet port for said aqueous solutions.
